(19) United States
(12) Patent Application Publication
(10) Pub. No.: US 2005/0229170 A1
(43) Pub. Date: Oct. 13, 2005

(54) Optimized system-level simulation

(76) Inventors: Matthew Bellantoni, Brookline, MA (US); William Neifert, Arlington, MA (US); Andrew Ladd, Maynard, MA (US); Matthew Grasse, Watertown, MA (US); Mark Kostick, Belmont, MA (US)

Correspondence Address: GOODWIN PROCTER LLP;PATENT ADMINISTRATOR, EXCHANGE PLACE, BOSTON, MA, 02109-2881, US

(21) Appl. No.: 10/820,459

(22) Filed: Apr. 8, 2004

(51) Int. Cl. G06F 9/44

(52) U.S. Cl. 717/165; 717/104

(57) ABSTRACT

Integration of a system-level simulation with one or more hardware device simulations is accomplished using a mapping layer, which allows the system-level simulation to interact with the hardware device simulation at a pin level, an object level, and an abstract level. The overall simulation may operate with respect to a clock or timing device or it may operate with respect to transactions.

### FIELD OF THE INVENTION

The present invention relates generally to hardware simulation and, more specifically, to high-speed, object-oriented hardware simulations.

### BACKGROUND OF THE INVENTION

Electronic hardware design is typically performed using register transfer level (RTL) descriptions of the device being designed. Hardware description languages such as Verilog allow hardware designers to describe the electronic devices that they are designing, and to have those descriptions synthesized into a form that can be fabricated.

The process of producing electronic devices is time-consuming and expensive. As a result, various simulation systems have been developed to permit hardware designs to be verified prior to actually producing an electronic device. Typically, a description of an electronic device is exercised using a simulator. The simulator generally includes a simulation kernel that runs the simulation either in software, or using simulation hardware, which typically consists of a collection of programmable logic devices or specially designed processing units. Use of simulation for the purpose of verifying hardware designs is a regular part of the hardware design cycle.

Many current hardware designs are intended to be used extensively in conjunction with software applications. Due to the slow speed of many current simulators, it may be necessary to delay much of the design and testing of such software until after early versions of the actual hardware become available. As a result, software development may not be possible until relatively late in the design cycle, potentially causing significant delays in bringing some electronic devices to market.

In view of the above, it is desirable to create high-speed simulations of the system so that software developers may begin working on applications while the hardware engineers are still designing the actual implementation. Some systems have, in fact, been developed to offer operating speeds sufficient to permit software testing. In other words, software developers can simulate the behavior of the modeled hardware in response to their code. Reaching such simulation speeds, however, generally requires operating trade-offs. For example, a high-speed simulation may not fully model the functionality of the hardware, perhaps abstracting components to the point of being accurate in terms of interface only. As a result, such a simulation is limited in its reflection of how the system—software and hardware—will eventually run. To improve modeling accuracy, as the hardware components are developed, simulations representing closer approximations of the actual devices may be introduced. But again, due to the trade-off between capability and speed, such simulations generally run slowly and consequently limit the efficiency with which hardware and software may be co-designed.

From the foregoing, it is apparent that there is still a need for a simulated hardware system that runs as close to real-time as possible, without sacrificing implementation-level detail.

### SUMMARY OF THE INVENTION

The present invention to increase the speed and versatility of hardware simulations by representing hardware components as executable objects that not only may be tested and run individually to simulate the behavior of a modeled hardware device, but which can be organized into a multi-object circuit modeling device behaviors and interactions among them. Using the invention, a designer may define objects to model the behavior of hypothetical or actual devices, and then define their interconnections and interactions. The invention allows objects to be integrated into diverse system-level environments, and also accommodates different types of objects. For example, objects may be re-used from different simulations or generated from templates, and the invention facilitates their intercommunication even if they are not configured for “native” communication within a new system-level environment.

In accordance with the invention, integration of objects within their environment (and, as a result, among themselves) may be accomplished by mapping between the objects and the environment at a functional level rather than the detailed interface level. This “abstract” mapping avoids clashes between, e.g., object and environment-level interfaces that have different timing requirements or operate at different levels of abstraction. A hardware object, for example, may “expect” to be called at every clock edge while the system-level environment operates at a higher level of abstraction, e.g., presenting data transactions only when data needs to be transferred into or out of the hardware object. Moreover, different types of transactions may themselves have different timing and data requirements.

In one aspect, therefore, the invention comprises a method for optimizing a system-level simulation of a hardware device. In accordance with the method, a system-level model is provided. The system-level model is divided into a plurality of functional blocks, and a mapping is provided between the system-level model and each of the functional blocks. Each functional block is compiled into at least one hardware object, which is linked with the system-level model.

Functional blocks may be represented in a hardware description language or in a high-level language (such as C, C++, SystemC, and/or Java). Hardware objects are typically expressed as compiled run-time code, and generally include an application-program interface (API) facilitating bidirectional data exchange with, and control of, the object. The APIs generally facilitate interface with other objects, with the system-level environment, and/or with application-level software programs (e.g., simulations). Each object API typically comprises a pin-level interface.

Mapping may involve API mapping and/or abstraction mapping. API mapping involves receiving input data from the system-level model, translating the input data into a format readable by hardware object, providing the input data to the hardware object, and translating output data from the hardware object into a format readable by the system-level model. In other words, API mapping may be limited to simple translation functions. For example, the system-level model may comprise an API presenting an interface accurate with respect to boundaries of a system clock but having system-specific data and access requirements, while hardware objects comprise APIs presenting an interface accurate with respect to boundaries of the system clock but having object-specific data and access requirements. API mapping reconciles the requirements of the system-level API and each object-level API so as to facilitate data interchange therebetween while maintaining adherence to the system clock.

Abstraction mapping, by contrast, typically involves an abstract interface to the system-level model and a pin-level interface to each hardware object. The system-level model comprises an API presenting an interface accurate with respect to transactions, while the hardware objects comprise APIs presenting an interface accurate with respect to the boundaries of a system clock. Abstraction mapping reconciles the transaction-based requirements of the system-level API and the clock-based requirements of the object-level APIs so as to facilitate data interchange therebetween while maintaining adherence to the system clock. In some embodiments, one or more control objects are provided. A control object controls advancement of time and execution of transactions to reconcile a transaction-accurate system-level API with clock-based object-level APIs.

Both abstraction mapping and API mapping may be accomplished by means of a mapping layer. In some embodiments, the mapping layer comprises one or more of a declaration module, a instantiation module, a sensitization module, an initialization module, an execution module, and an output scheduling module. The declaration module defines a wrapper module inside the system-level model for accessing hardware objects. The instantiation module creates an instance of a hardware object; the instance includes at least one data structure, which receives data from the mapping layer. The sensitization module detects a change to a pin of a pin-level interface to a hardware object; the change represents a signal which, if applied to a pin of the actual hardware element corresponding to the hardware object, would affect an output pin of the hardware element. The change may, for example, comprise assertion of a clock signal, an asynchronous reset signal, and/or a signal affecting an output pin without requiring toggling of a system clock. The initialization module assigns at least one value to one or more data structures associated with the object, thereby initializing the data structure(s). The execution module copies input data from the mapping layer to a hardware object, executes the hardware object in accordance with the input data, and copies output data from the hardware object to the mapping layer. The output scheduling module determines when output data is copied from the mapping layer to the system-level model.

In another aspect, the invention comprises an apparatus for integrating a system-level simulation and a hardware device. The apparatus comprises a system-level model divided into a plurality of functional blocks, each of which is represented by a hardware object linked to the system-level model; and a mapping layer between the system-level model and the functional blocks as described above. In some embodiments, the mapping layer comprises an API mapping module configured to receive input data from the system-level model, to translate the input data into a format readable by a hardware object, to provide the input data to the hardware object, and to translate output data from the hardware object into a format readable by the system-level model. The mapping layer may comprise an abstraction mapping module that itself comprises an abstract interface to the system-level model and a pin-level interface to a hardware object. In some embodiments, the apparatus further comprises one or more control objects, and as discussed above, these control advancement of time and execution of transactions to reconcile the transaction-accurate system-level API with the clock-based object-level APIs.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1A is a flowchart depicting a method for optimizing a system-level simulation of a hardware device in accordance with an embodiment of the invention;

FIG. 1B schematically illustrates a system-level model involving multiple hardware objects and supporting intercommunication therebetween;

FIG. 1C schematically illustrates the organization of a typical hardware object created in accordance with FIG. 1A;

FIG. 1D is a flowchart illustrating an execution process flow according to which the hardware simulation takes placed across all objects;

FIG. 2 is a flowchart depicting a method for simulating hardware parallelism in accordance with the invention;

FIG. 3A schematically illustrates the components involved in the execution of a simulation in accordance with the invention;

FIG. 3B is a flowchart depicting execution of a simulation in accordance with the invention;

FIG. 4 schematically illustrates interaction among objects in a simulation; and

FIG. 5 schematically illustrates a scenario where a race condition exists.

### DETAILED DESCRIPTION

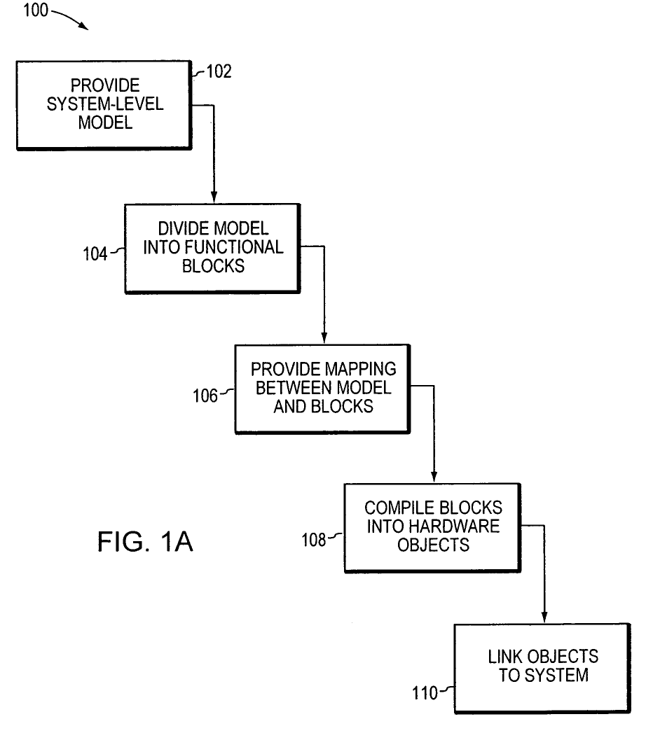

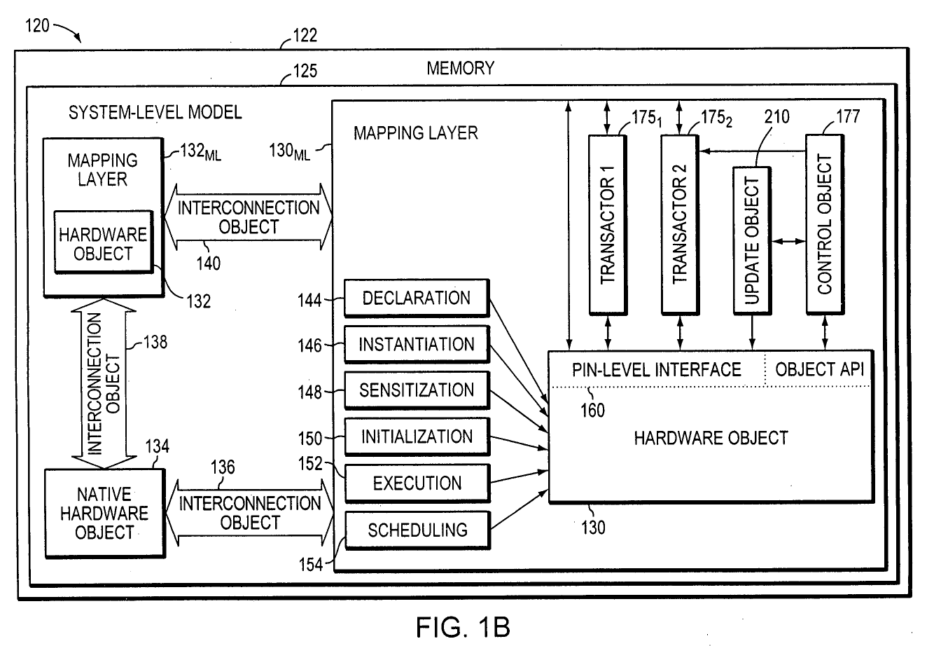

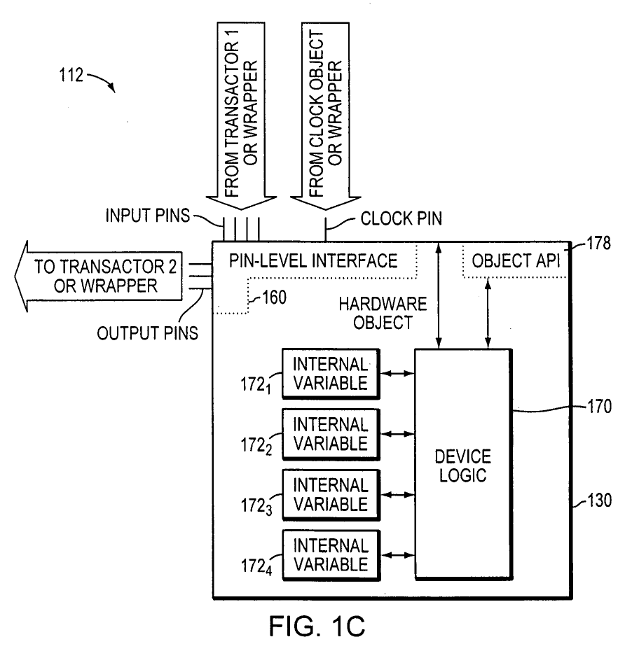

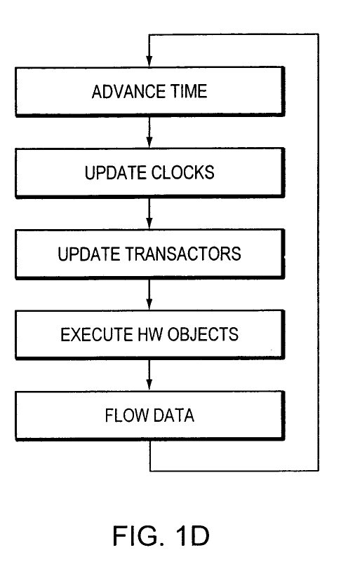

In brief overview, FIG. 1 is a flowchart depicting a method 100 in accordance with an embodiment of the invention for optimizing a system-level simulation of a hardware device to achieve a balanced simulation of low-level hardware specifics at high run-speeds. Broadly, the method provides a system-level model or execution environment (STEP 102), divides the model into functional blocks of high-level code (STEP 104), provides a mapping between the system-level model and the functional blocks (STEP 106), and compiles the functional blocks into API-accessible, run-time object code (STEP 108). For example, if the source code (i.e., functional block) of a FIFO buffer was written in C and stored in a file named fifo.c, the compiled run-time object code may reside in a file named fifo.o (hardware object). Pre-compiled objects in some embodiments are recompiled. Following compilation (STEP 108), the run-time hardware objects are linked (STEP 110) to the system-level model. The linking generally creates a binary executable object that may be run individually or as part of a larger simulation system. The executable may be run interactively by a user or automatically as part of a batch system.

In one embodiment, the method 100 begins by providing a system-level model (STEP 102) such as a SystemC design environment. The system-level model, written in a software language such as, but not limited to, SystemC, emulates a physical system at a high level. In a simple example, a system-level model may represent a hand-held calculator, with functions for adding, subtracting, multiplying and dividing. Initially, the calculator model may implement a function such as adding by taking in two parameters and utilizing the native “+” implementation provided by the programming language. Using high-level methods to emulate functionality is advantageous in terms of performance, but does not reflect the way a real system would behave. To emulate actual system behavior, it is necessary to model the steps performed by a real calculator. The parameters would be put into physical registers within the system, a binary addition would be performed on the registers, the result would be put on a data bus, and the output would be read from the bus and displayed on a screen. While emulating each register and bus of a calculator is fairly simple, emulating every component of a system such as a desktop computer is a far more complex task not amenable to real-time modeling. Therefore, the system-level model is divided into functional blocks (STEP 104) of code representing the higher-level hardware components of the system, so that each component may be developed independently from the rest of the system.

Once the system-level model is divided into functional blocks (STEP 104), application programming interfaces (APIs) to those blocks are provided. The APIs mimic the way a physical system would interact with the hardware device being modeled. Using the calculator example, the physical calculator may have an adder component that has two sets of data-in pins and one set of data-out pins. The physical calculator would place the parameters on the adder's data-in pins and on the next system clock cycle, check the data-out pins for the result (though it should be noted that the addition step may be performed asynchronously). The binary addition step is performed by the adder component. Like the physical calculator, the calculator model may have an adder functional block that takes in two input parameters and presents one output parameter. The model would pass in the parameters to be added and on the next simulated clock cycle it would read the output, parameter. This behavior mimics the way the physical calculator's components interact. In a physical system, components are generally not aware of the implementation specifics of other components; they only “see” the other components' input and output pins.

Communication between functional blocks defined within the system-level model is trivial; the system developer has direct access to a functional block's inputs and outputs through native APIs (i.e., APIs specifically associated with the functional block and consistent with other APIs used with the system-level model) or address pointers. It is desirable, however, to allow the system-level model to also interact with functional blocks written outside the system (“hardware objects”) as if they were natively defined, i.e., written expressly for interaction with the system environment. Developing hardware objects outside the scope of a specific system allows developers to reuse objects they have created for other systems, to use programming languages with which they are already comfortable, or even to incorporate proprietary hardware objects for which they may not have the source code. These hardware objects may be written using any of a number of programming languages such as, but not limited to, Verilog, HDL, C, C++, SystemC, Java, or low-level assembly. The objects may be source code or object code that was compiled using a compiler such as the SPEEDCompiler program supplied by Carbon Design Systems, Inc., Waltham, Mass. However, because such reused objects are not native to the system-level model, and the system therefore is not configured to interact with them directly (e.g., their values or pointers are not natively defined with respect to the system-level model), a mapping layer or “wrapper” is provided (STEP 106) to enable the system-level model to communicate with non-native hardware objects. The wrapper provides a defined interface, generalized with respect to the hardware device being simulated, with which the system-level model—i.e., other objects defined within the system-level model or aspects of the model itself—may interact while hiding the details of declaring and instantiating the objects, as well as facilitating any communications that may flow from one object to another. Beneficially, this allows the developer to swap hardware object files during the compile (STEP 108) or linking (STEP 110) step in favor of more efficient or more complete implementations. For example, a system-level model emulating a desktop computer may examine the value on the data-out pins of a soundcard. An object provided by a first vendor may refer to the pointer representing the data-out pins as sndCard.d_out. An implementation of the same object provided by a second vendor may refer to the same pins using a pointer named soundCard.dataOut. To swap the objects in a system that does not utilize a wrapper, the system-level model code would need to be changed to import, declare, and instantiate the correct object instance and to call the appropriate variable. Instead, one embodiment of the present invention allows the system to interact with wrappers in a standard, unchanging manner and let each wrapper declare the correct object, instantiate it, and map the inputs and outputs from the system to the correct hardware object variables. With reference to FIG. 1B, a simulation 120 in accordance with the invention is realized within the execution memory 122 of a general-purpose computer. A system-level model 125 (actually executed as run-time code but conceptually organized as illustrated) includes three hardware objects 130, 132, 134. The objects 130, 132 are non-native and therefore have associated mapping layers 130_{ML}, 132_{ML}. A series of interconnection objects 136, 138, 140 facilitate simulated communication among the objects 130, 132, 134.

The mapping that the wrapper creates (“mapping layer”) typically has several modules that facilitate object creation and communication: the declaration module 144, the instantiation module 146, the sensitization module 148, the initialization module 150, the execution module 152, and the output scheduling module 154. It is understood that the following description pertains, in reference to the steps of instantiation, initialization and execution, to run-time behavior of a hardware object and a system-level model. All steps may be coded before the compilation step of the method 100, but the interactions described pertaining to the instantiation, initialization, and execution of the object, preferably occur at run-time. The first step performed by the mapping layer is declaration, though as one skilled in the art is aware, declaration, instantiation, and initialization may take place in any order and/or the steps (or aspects thereof) may interleave depending on the developer's implementation style and practices.

In one embodiment of the present invention, a wrapper 130_{ML} begins object declaration by importing a library that defines the necessary classes or data structures that represent the hardware object 130. The library contains a template of what the object will be, defining inputs and outputs (including a pin-level interface 160) as well as functions and methods, e.g., constructors, which create objects from templates, and entry methods, which provide system-level access to an object, accessible to a calling object or environment. The wrapper 130_{ML} will use this template to create “handles” that facilitate access to the object, e.g., a pointer to an address in memory, to the hardware object and/or to its components for a calling system to access once the object is instantiated. Because the object, its variables and methods are shielded from the system-level model 125 by the wrapper 130_{ML}, the wrapper 130_{ML} will use the handles to pass data between the system 125 and the object 130, reading from and writing to the handles as appropriate. For example, to simulate a FIFO buffer, a handle is declared for the buffer itself, its reset pin, its push clock pin, and its data-in pins. In some embodiments, the wrapper provides a one-to-one mapping of inputs and outputs. For instance, using the FIFO example, a single-bit port of the hardware device such as the reset or push clock may each be represented as a single Boolean variable. In other embodiments, the wrapper may use a one-to-many mapping, a many-to-one mapping, or a many-to-many mapping. Multiple single bit ports, such as a set of data-in pins on the FIFO, may be mapped to a single unsigned integer value (with the lowest significant digit, in binary representation, corresponding to the first pin of the data-in set of pins). The wrapper generally performs these translations via mapping functions. For example, an input that is presented in an 8-bit representation at the system level may be converted to a 32-bit representation at the hardware object level by running the 8-bit number through a 32-bit adder. Though the mapping is still considered one-to-one, the input is translated into a format the hardware object can accommodate. Handles typically represent an input or output for the hardware object, but in some embodiments, a handle is declared to access a waveform of the signals that flow through the hardware object. Such a waveform allows for generation of a human-readable graph of what data went into and out of the hardware object at what time and may be used for performance measurements and hardware design decisions. This pin-to-pin mapping is commonly referred to as API mapping and is generally cycle accurate and clock-bound.

Once declaration is complete, the hardware object may be instantiated by the instantiation module 146. Instantiation takes the template provided by the declaration module and creates a blank hardware object in memory. The object and its components, such as the input and output variables, now exist in memory but are not yet “hooked in” to the inputs and outputs of the local variables of the mapping layer. The system-level model, the wrapper, and the hardware object all exist in memory, but system-level model may not communicate with the hardware object's components, and vice versa, yet. The initialization module 150 obtains, from the object that was instantiated, pointers to its internal variables representing the pins and methods to be exposed, assigning them to the local variables and methods, respectively, of the wrapper. Once this has been completed, the system-level model may access the hardware object via the wrapper. The hardware object may raise events to the system-level model through the wrapper as well.

Before a hardware object is executed, it is sensitized to changes on its inputs via the sensitization module 148. Sensitization involves making the system-level model aware of every change to a hardware object's inputs that will result in the changing of one of its outputs. For example, if a new value placed in the push clock variable of a FIFO object causes the object to place data into its data-out variable, then the system-level model is “sensitive” to the change of the hardware object's push clock. The collection of signals that influence object output is termed a “sensitivity list.” The wrapper 130_{ML} makes the system-level model 125 aware of the hardware object's sensitivity list by passing the sensitive pins of the pin-level interface 160 to the system-level model 125 and registering those pins with the system-level model. In some embodiments, the system-level model's execution kernel, when it attempts to put values into the pin variables, will raise an event that will “wake up” the hardware object 130 to the forthcoming changes to its input pins. Typical signals to which an object is sensitive to include changes to its clock pin, changes to asynchronous reset pins it may have, or changes to inputs which cause changes to the object's output pins, yet do not require the toggling of a clock or a reset. In any of these instances, and others, the sensitivity list may be level sensitive as opposed to edge sensitive.

Once the object 130 is instantiated, sensitized, and initialized, the object 130 may be executed via the wrapper 130_{ML} by signals from the system-level model 125 (i.e., signals produced by other objects in accordance with the system-level design or from other system-level components). The system-level model 125 communicates with the wrapper 130_{ML} as if it were communicating with a hardware device, placing inputs into the wrapper's input variables as if they were the pins of the physical object. The wrapper checks for changes to the input variables defined in the sensitivity list and if there are changes, the wrapper passes the inputs to the corresponding handles of the instantiated hardware object's components. The hardware object executes and places output data in its output variables. The wrapper then copies the data from the handles of the object's output variables to its output variables, thereby returning output data from the simulated hardware to the system-level model at the expected output pins (via the pin-level interface 160).

A more detailed view of object organization is shown in FIG. 1C. A hardware object models device operation through a functioning representation of the device's internal logic 170, as well as internal variables 1721, 1722, 1723, 1724 that are used by the device. The device logic 170 is responsive to input values and signals (e.g., clock signals) received via the pin-level interface 160, processing them in the manner the physical hardware device would, and communicates output values via that interface. The manner in which simulated inter-object communication occurs is described in greater below. A wrapper, if necessary, operates as a second interface layer as indicated.

The interaction between an object's wrapper and the system-level model may follow the boundaries of the system's clock(s), operating in the one-cycle-to-one-cycle mode described above, or the two may utilize an transaction-based interaction model. In a transaction-based simulation, the system-level model calls the wrapper only when necessary, skipping potentially thousands of “ticks” (each of which represents an absolute measure of system time not necessarily coinciding with a clock cycle) at a time. A non-cycle-accurate system is useful when writing higher-level application software or hardware drivers. For example, rather than being required to set every individual pin required to a complete transaction, which may iterate over several clock cycles, a system may instead simply call a busObject.write( ) method and pass in an array representing the value to be written. This step, known as “abstract mapping,” effectively takes an abstract concept such as a write command and turns it into a series of transactions and pin interactions that the object-calling system need not execute directly. The system therefore is not bogged down calculating its state for every clock cycle if nothing significant is occurring. Instead, the system is allowed to jump to the points in the system/hardware interaction that are useful to the developer.

In an abstract mapping scenario, an arrangement similar to the one above is used, i.e., a system-level model interacts through a wrapper with a hardware object. However, because the system issues high-level abstract commands while the hardware object is expecting low-level changes to its pins, translation objects or methods are employed to facilitate communication. With reference to FIG. 1B, residing inside the wrapper module 130_{ML} are transactor objects representatively indicated at 175₁, 175₂ that, in conjunction with a control object (discussed below) act as abstract-to-pin-level translators and facilitate interaction between the system level and the object level. The transactor object 175 has two interfaces, namely, an abstract interface that “faces” the system-level model 125 and a pin-level interface that “faces” pin-level interface 160 of the hardware object 130. Instead of communicating with the system-level model 125 through the mapping layer 130_{ML} via API mapping (i.e., direct pin-to-pin interaction), the object 130 communicates through the mapping layer 130_{ML} via the transactors 175. Unlike the pin-to-pin interfaces provided by API mapping, however, the transactor's abstract functions available to the system-level model 125 are high-level operations such as read( ) and write( ). Whereas the pin-level interface of the transactor remains shielded from the system-level model, the hardware object's pin-level interface 160 may be exposed through API mapping. Transactors may act as initializers for the hardware object, setting the object to expected states for certain transactions (e.g., resetting a bus value if necessary before a write is performed). Similarly, they may copy data to the inputs of the hardware object 130, call the object's execution routine, and present output data to the system-level model 125. The difference between communication via API mapping and abstract mapping lies in how data gets into and out of the object 130 (e.g., wrapper-to-object for API mapping and wrapper-to-transactor-to-object for abstract mapping) and how that relates to object timing.

An abstract function such a write operation is, at the implementation level, composed of a series of pin state changes. For example, a physical hardware component, before filling a data bus, may first request permission to write to the bus. It may do this on its first clock cycle (read from a clock pin). Permission to write may not be granted on the next clock cycle but may be granted on, for example, the third, at which point the hardware actually writes data to the bus pins. Lastly a write acknowledgement may be returned on the fourth cycle. In the API-mapping approach, the system-level model 125 iterates through each clock cycle, computing the entire state for each object on each cycle —even though, as in this example, not every cycle is relevant to the operation of the hardware component in question. In abstract mapping, the system-level model 125 may issue a bus.write( ) command and jump ahead four clock cycles to the next point in the simulation relevant to that command, i.e., the point where that value is written to the bus, or later still, e.g., to a point where execution of the command is relevant to the simulation as a whole (such as when the write data is actually used). Because abstraction mapping does not necessarily depend on a system clock, yet typically needs an internal notion of time, the mapping layer 130_{ML} may include a control object 177 to determine when to advance to the next point in the transaction and in the system-to-object interaction timeline. Aside from pin-level or abstract interactions that model system/hardware object behavior, hardware objects may expose to the system, through the wrapper, an object API 178 comprising methods that relate specifically to the object as a piece of software. Such routines may be, but are not limited to, execution routines, diagnostics, garbage-collection routines, destructors, or other methods that may not relate to modeling system/hardware interactions. Coordinating transactions within the abstract mapping is discussed below.

The overall execution flow in an abstract-mapping regime is shown in FIG. 1D. Time is advanced to the next meaningful point in the simulation, following which all system clocks and transactors are updated. Execution-ready hardware objects (i.e., objects having inputs or other events indicating execution readiness) are executed, after which data is flowed from the objects, and the process repeats.

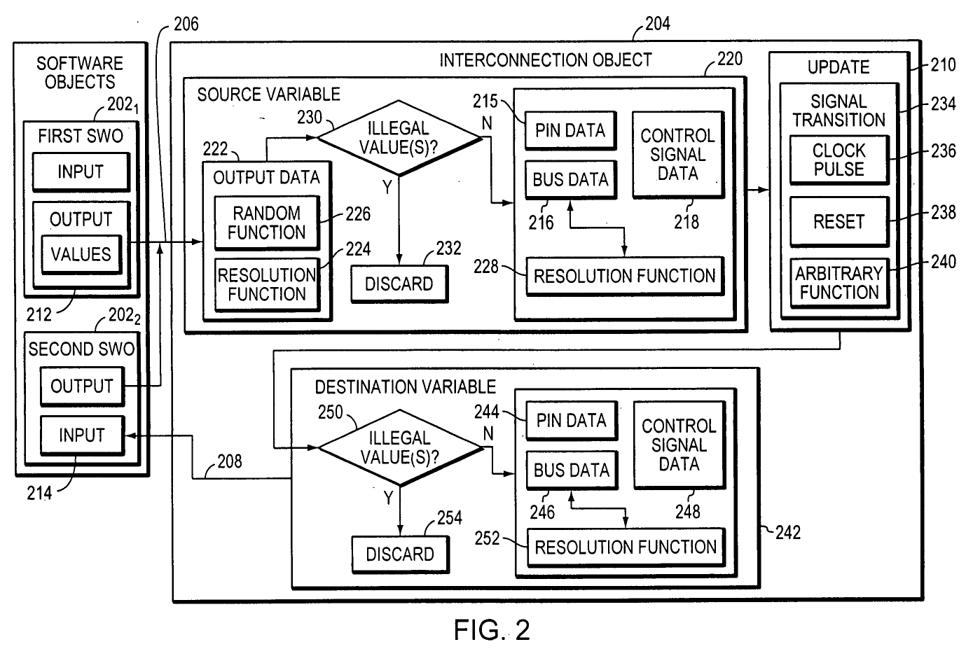

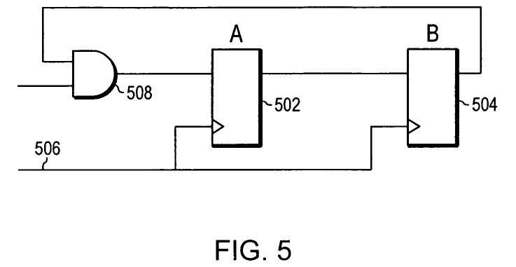

Though software typically processes methods and function calls sequentially, hardware often executes events in parallel. It may be necessary for certain hardware operations to take place before others can validly take place (e.g., “race conditions” described below in connection with FIG. 5). FIG. 2 illustrates an approach to simulating hardware parallelism using interconnection objects. Interconnection objects may be used to facilitate data sharing between hardware objects as part of a cycle-accurate, system-clock-bound simulation. Broadly, a plurality of hardware objects 202₁, 202₂ are initially provided, as are at least one interconnection object 204 which stores outputs (as indicated at 206) and inputs (as indicated at 208) associated with the hardware objects. The interconnection objects provide these values to the appropriate destination objects for storage and retrieval after receiving an update command 210. It is the update command that prevents premature use or transfer of values among objects.

In some situations, two hardware objects are involved, e.g., the output 212 of the first hardware object 202₁ provides input 214 for the second hardware object 202₂. In other situations, only a single object is involved, i.e., the output of the object is additionally used as an input to the object. Still other situations involve multiple hardware objects, each with multiple inputs and outputs. In any of these situations, data is not transferred directly between objects; instead, output data on the pins of a hardware object is copied to the inputs of the interconnection object 204, and the interconnection object 204 stores this output until transfer is appropriate. Output data 222 may be in any form produced by a hardware object. It may be, but is not limited to, a single value (e.g., simulating a single pin 215) or an array of values (e.g., from a single object or multiple objects); a series of values (e.g., bits) for a given period of time (e.g., a multitude of bus states for a given bus 216 for a specified interval); one or more control states (e.g., 1, 0, X or Z) for a given control signal 218; a series of bits from one or more simulated hardware pins representing a single state from each of one or more buses for a given point in time; and/or a single state from each of one or more control signals for a given hardware object.

The interconnection object 204 generally contains one or more source variable(s) 220, or placeholders in memory, to store data relevant to the interaction between hardware objects. These source variables serve as holding points for data that flows from one component or series of components to another. Output data 222, which may originate from multiple hardware objects (e.g., the objects 202₁, 202₂ as shown), en route to the source variable(s) 220 of the interconnection object 204, may also be processed through one or more functions. In one embodiment, one function is a resolution function 224 which may, for example, select one output data value from a group of competing data values using specified criteria. Examples of such functions are an AND function or an XOR bitmask. In another embodiment, one function is a random value function 226. Examples of the random function 226 include assigning a random value based on a system call, using a preset value, or randomly choosing between the competing values. In yet another embodiment, a resolution function accommodates multiple drivers for a single signal or bus 228, such as a bus that is expected to have “noise” values on it (e.g., a modem's data-in bus). As the interconnection object 204 receives the output data, validity checks 230 may be performed thereon to avoid storing illegal values (e.g., a clock signal having a value that is neither zero nor one). Any illegal values may be discarded (as indicated at 232), ignored, or output for diagnostic purposes. After receiving the output data and excluding illegal values, the source variable 220 stores the output data.

After the output data is stored in the source variable 220, the interconnection object 204 receives an update command 210 at the end of the current “time” indicating that the current time in a clock-bound system or the current transaction in a transaction-bound system is complete (or nearly so). The update command is generally issued before the next signal transition 234 occurs, which may be, but is not limited to, a clock pulse 236, a reset 238, or the result of an arbitrary function 240 such as a “slow” serial bus or a network packet delay emulator. An arbitrary function 240 typically includes cycle time as an independent variable. In some circumstances, the update command may be received immediately after the output data is stored. In other circumstances, the command may be received after one or more other hardware objects are executed. Waiting for an update command to flow data, rather than propagating data immediately between components, allows the system to correctly model certain behaviors while respecting hardware parallelism, e.g., avoiding “race conditions.” An example of a race condition is shown in FIG. 5, where two storage elements, flip-flops A (502) and B (504), share a common clock 506. The output of element A is an input to element B and the output of element B is an input to element A (via an intermediate AND gate 508). In physical systems, the clock signal 506 is applied to both storage elements at the same time and the correct results are obtained. In simulated systems, due to a programming language's generally serial nature, these storage elements are typically executed sequentially. However, if the hardware object representing storage element A is executed before the hardware object representing storage element B, the output of element B may be incorrect since it will be calculated based on the new value of element A rather than the old value. Likewise, if the hardware object representing storage element B is executed before the hardware object representing storage element A, the output of element A may be incorrect since it will be calculated based on the new value of element B rather than the old value. While this problem may be solvable from within an existing functional block using temporary variables, it is non-trivial when storage elements A and B represent different functional blocks that are compiled separately. In that scenario, each storage element will be represented in separate hardware objects. The environment containing the software objects may have no knowledge of the data-flow dependencies between the objects and may execute them sequentially, allowing the output of one storage element to propagate directly to the input of the other. This results in the output of a simulation differing from the output of a physical system. An interconnection object overcomes this deficiency by effectively creating a pause within the system in relation to data propagation. Since the driving of data and propagation of data are separated into different steps, e.g., storing the data and then flowing it upon receipt of an update command, the source and destination of the data need not to be in the same process, nor do even on the same computer. Using the provided example, the value of element A may be calculated based on its previous inputs (but its new output not yet provided to element B) and the value of element B may be calculated based on its previous inputs (but its new output not yet provided to element A). Once both have been calculated, data is propagated and the next time interval is reached. The process of copying the data from source to destination may be as simple as a memory copy or as complex as an inter-process communication mechanism such as POSIX sockets or TCP/IP communications. This ability allows simulations of multiple objects to take place across multiple processes, multiple processors and multiple computers. Beneficially, this enables large systems to be executed in a small fraction of the time which would be required for a monolithic simulation.

Once the update command 210 is received, the interconnection object 204 next copies data from the source variable 220 to the destination variable 242. Delaying the copying operation until the update command 210 is received allows hardware objects to use the current state of the simulated hardware up to the very last iteration or operation of the system before the system time or state is advanced. The destination variable 242 is generally similar to the source variable 220. The destination variable may contain, for example, a single value; an array of values; a series of values (e.g., bits) intended to correspond to a simulated hardware pin 244, such as multiple bus states 246 for a given bus over a period of time; multiple states for a single control signal 248 going to a hardware object; a series of bits intended for multiple simulated hardware pins for a single point in time, e.g., a single state from each of a multitude of buses; or a single state from each of a plurality of control signals going to a hardware object. As the data from the source variable 220 is copied to the destination variable 242, validity checks 250 may be performed on the incoming data so as not to store any illegal values. One such check may be a resolution function to accommodate multiple drivers for a single signal or bus 252 such as WAND or WOR buses. Any illegal values may be kept in a separate memory for diagnostic purposes or may be discarded (as indicated at 254). A valid value or values is (are) stored in the destination variable(s) 248 of the interconnect object 204.

After the copy is made from the source variable 220 to the destination variable 242, the second hardware object 2022 receives (as indicated at 208) the value(s) in the destination variable(s) 242 as input 214. Again, the objects 202₁, 202₂ may be the same object or different objects (or multiple objects). Though FIG. 2 illustrates one embodiment of the invention, it is understood that an interconnection object may in fact have components, e.g., source variables 220 and destination variables 242, in separate processes, separate processors, or on separate computers across a network using, for example, TCP/IP sockets, to share data.

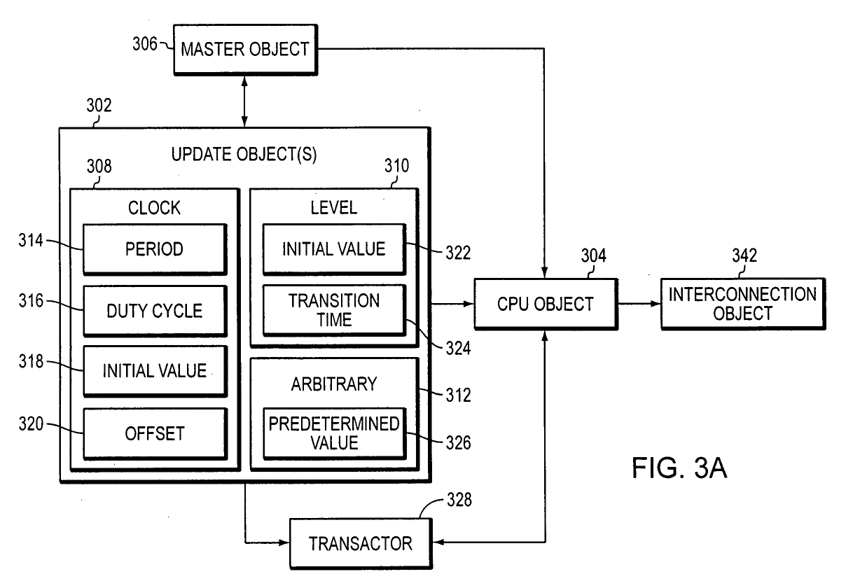

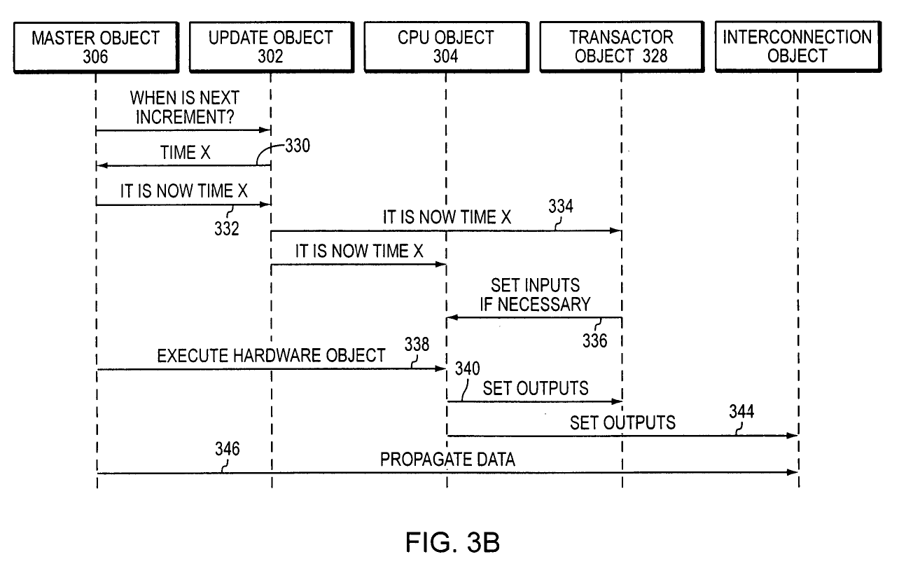

Although interconnection objects avoid problems of parallelism and inconsistent timing, even clock-bound hardware objects may not be synchronized to a system-wide clock; indeed, to increase simulation speed it is desirable to avoid unnecessary cycle executions and instead confine transaction processing to meaningful operations. This may be accomplished as illustrated in FIGS. 3A and B, which show an update object 302 that governs the perception of time for a hardware object 304 (as described above), and a master object 306 (also known as a “control object”) that advances the update object 302 given certain conditions.

Referring to FIG. 3A, each update object 302 has particular initialization and increment criteria. Update objects may be, but are not limited to, objects representing a clock (“clock object”) 308, objects that emulate a signal level (“level object”) 310 such as a modulation that changes upon reaching a threshold, or objects that represent arbitrary functions 312 such as the output of a “slow” serial bus or a network packet delay emulator. Arbitrary function objects 312 typically include functions that have cycle time as an independent variable. Each update object generally has its own types of initialization criteria. These criteria define the initial or start-up state of the object. For example, in some embodiments, a clock update object 308 has as initialization criteria one or more of a period 314, a duty cycle 316, an initial value 318, and an offset 320 (e.g., a phase shift or a time offset from time 0 to begin execution). In other embodiments, a level update object 310 has as initialization criteria one or more of an initial value 322 and a transition time 324. In yet other embodiments, an arbitrary function object 312 has a predetermined value 326 corresponding to a predetermined time as its initialization criteria. In other words, the arbitrary function object 312 is set to a specific value associated with a specific cycle time (in accordance, for example, with user-provided input data).

The update objects 302 are generally in communication with one or more hardware objects 304. The hardware objects 304, which are responsive to communications from the update objects 302, are also in communication with, in some embodiments, transactor objects 328 that perform various abstract functions (e.g. read( ) and write( ) as described above). The communications sent by the update objects 302 and transactors 328 to the hardware objects 304 may be, but are not limited to, method calls, functions, or changes to the objects' input pins.

The master object 306 generally is in communication with both the update objects 302 and the hardware objects 304 and generally provides overall control. Referring to FIG. 3B, the master object 306 receives from an update object 302 the update object's next transition “time” (STEP 330). (In this context time is represented as ticks, i.e., the non-cycle-dependent notion of time mentioned above.) The master object 306 then advances (STEP 332) the update object 302 according to the increment criteria received, effectively instructing the update object 302 that it is now “that time” and the update object sets itself, e.g., places values on its output “pins” accordingly. The update object 302 may also coordinate with transactors 328, instructing them that it has incremented the time (STEP 334) and, in response, the transactors 328 may present data to the hardware object as input for the hardware object's next execution (STEP 336). The master object 306 then commands the associated hardware object (STEP 338) to execute which in turn initializes itself with respect to (i) the state of the update object with which it is in communication, and (ii) inputs from interconnection objects. The hardware object, on execution, then generally provides data to transactors (STEP 340) and/or interconnection objects 342 (STEP 344) for storing and eventual forwarding to other hardware objects. The master object then instructs the interconnection objects relevant to this hardware object's execution to propagate the date (STEP 346). For example, the master object 306 may request the next transition time of an update object 302 (e.g., a clock), and thereupon instruct the clock to increment itself to this next transition. If the master object 306 is coordinating time for multiple update objects, it may advance time to the next lowest transition time among the controlled objects (e.g., if a clock has a cycle of 50 ticks and a level has a transition at 30 ticks, after time 0, the master object 306 advances time 30 ticks). The master object 306 then instructs the hardware object 304 (e.g., a CPU) to execute by calling its execution routine. The CPU object 304 examines its clock pin and sets itself to the expected state for the point in time to which the master object 306 has advanced the clock; the CPU object's expected state at this time is determined by its inputs (which may come from interconnection objects in communication with this hardware object). The CPU object 304 executes its methods and functions and may send output data to an interconnection object 342, which, for example, may be in communication with another hardware object acting as a co-processor. The master object 306 then instructs the interconnection object 342 to propagate the data. The system cycle for this point in time then finishes. The master object 306 thereupon instructs the update objects 302 it is in communication with to increment to the next lowest transition, and the sequence of operations is repeated. It should be understood, of course, that the foregoing represents only one exemplary embodiment and that others embodiments will have different components and task schedules.

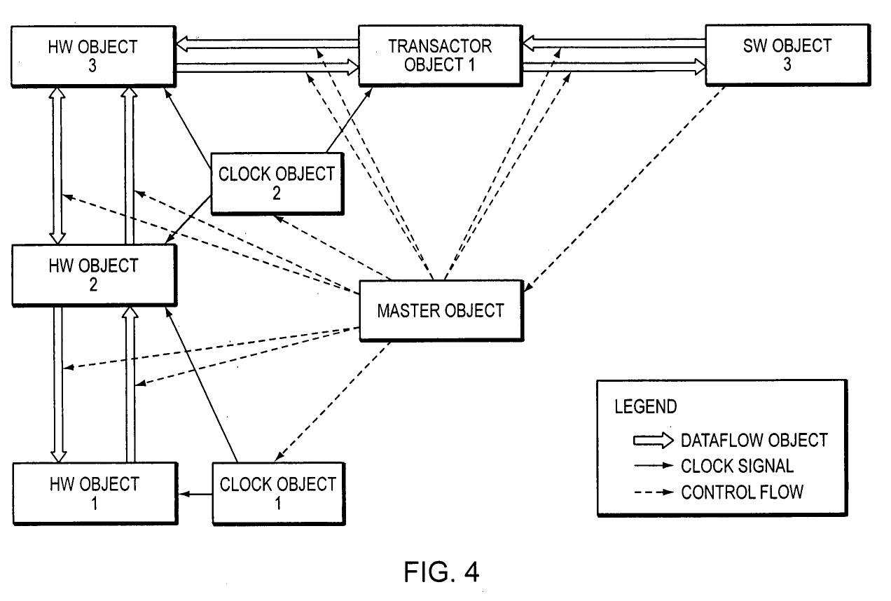

Refer now to FIG. 4. Whereas FIGS. 3A and B illustrate one embodiment of the invention in which a single hardware object was controlled by a single master object and a single update object, FIG. 4 illustrates the ability of the invention to support multiple update objects, in this embodiment clock objects, which drive multiple hardware objects. A single master or “control” object in turn coordinates the clock objects.

From the foregoing, it will be appreciated that the systems and methods provided by the invention afford an efficient method for integrating a hard device represented in software into a system-level simulation, a method for communicating between hardware objects, and a method of control the execution of the objects and the communications between them.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

1. A method for optimizing a system-level simulation of a hardware device, the method comprising the steps of:
providing a system-level model;
dividing the system-level model into a plurality of functional blocks;
providing a mapping between the system-level model and each of the plurality of functional blocks;
compiling each functional block into at least one hardware object; and
linking the at least one hardware object with the system-level model.

2. The method of claim 1 wherein the at least one hardware object is expressed as compiled run-time code.

3. The method of claim 1 wherein each functional block is represented in at least one hardware description language.

4. The method of claim 1 wherein each functional block is represented in at least one high-level language.

5. The method of claim 4 wherein the high-level language comprises at least one of C, C++, SystemC, and Java.

6. The method of claim 1 wherein the at least one hardware object comprises an API.

7. The method of claim 6 wherein the APIs facilitate interface with application-level software programs.

8. The method of claim 6 wherein each object API represents a pin-level interface corresponding to a hardware element.

9. The method of claim 1 wherein the mapping step comprises at least one of the steps of API mapping and abstraction mapping.

10. The method of claim 9 wherein the mapping step comprises API mapping, the API mapping step itself comprising:
receiving input data from the system-level model;
translating the input data into a format readable by at least one hardware object;
providing the input data to the at least one hardware object; and
translating output data from the at least one hardware object into a format readable by the system-level model.

11. The method of claim 10 wherein (i) the system-level model comprises an API presenting an interface accurate with respect to boundaries of a system clock but having system-specific data and access requirements and (ii) the at least one hardware object comprises an API presenting an interface accurate with respect to boundaries of a system clock but having object-specific data and access requirements, the mapping step reconciling the requirements of the system-level API and each object-level API so as to facilitate data interchange therebetween while maintaining adherence to a system clock.

12. The method of claim 9 wherein the mapping step comprises abstraction mapping, the abstraction mapping itself comprising an abstract interface to the system-level model and a pin-level interface to at least one hardware object.

13. The method of claim 12 wherein (i) the system-level model comprises an API presenting an interface accurate with respect to transactions and (ii) the at least one hardware object comprises an API presenting an interface accurate with respect to the boundaries of a system clock, the mapping step reconciling the transaction-based requirements of the system-level API and the clock-based requirements of each object-level API so as to facilitate data interchange therebetween while maintaining adherence to the system clock.

14. The method of claim 13 further comprising providing a control object, the control object controlling advancement of time and execution of transactions to thereby reconcile the transaction-accurate system-level API with the clock-based object-level APIs.

15. The method of claim 9 further comprising the step of defining a mapping layer.

16. The method of claim 15 wherein the mapping layer comprises a declaration module, a instantiation module, a sensitization module, an initialization module, an execution module, and an output scheduling module.

17. The method of claim 16 wherein the declaration module defines a wrapper module inside the system-level model for accessing the at least one hardware object.

18. The method of claim 16 wherein the instantiation module creates an instance of the at least one hardware object, the at least one hardware object comprising at least one data structure, wherein the at least one data structure receives data from the mapping layer.

19. The method of claim 16 wherein the sensitization module detects a change to a pin of a pin-level interface to the at least one hardware object, the change representing a signal which, if applied to a pin of a hardware element corresponding to the at least one hardware object, would affect an output pin of the hardware element.

20. The method of claim 19 wherein the change comprises assertion of at least one of (i) a clock signal, (ii) an asynchronous reset signal, and (iii) a signal affecting an output pin without requiring toggling of a system clock.

21. The method of claim 16 wherein the at least one hardware object comprises at least one data structure, wherein the initialization module assigns at least one value to the at least one data structure, thereby initializing the at least one data structure.

22. The method of claim 16 wherein the execution module copies input data from the mapping layer to the at least one hardware object, executes the at least one hardware object in accordance with the input data, and copies output data from the at least one hardware object to the mapping layer.

23. The method of claim 16 wherein the output scheduling module determines when output data is copied from the mapping layer to the system-level model.

24. An apparatus for integrating a system-level simulation and a hardware device, comprising:
a system-level model divided into a plurality of functional blocks, each functional block being represented by at least one hardware object linked to the system-level model; and
a mapping layer between the system-level model and each of the plurality of functional blocks.

25. The apparatus of claim 24 wherein each hardware object is expressed as compiled run-time code.

26. The apparatus of claim 24 wherein each functional block is represented in a hardware description language.

27. The apparatus of claim 24 wherein each functional block is represented in at least one high-level language.

28. The apparatus of claim 28 wherein the high-level language comprises at least one of C, C++, SystemC, and Java.

29. The apparatus of claim 24 wherein each hardware object comprises an API.

30. The apparatus of claim 29 wherein the API facilitates interface with application-level software programs.

31. The apparatus of claim 29 wherein the API is a pin-level interface corresponding to a hardware element.

32. The apparatus of claim 29 wherein the mapping layer comprises an API mapping module configured to (i) receive input data from the system-level model, (ii) translate the input data into a format readable by a hardware object, (iii) provide the input data to the hardware object, and (iv) translate output data from the hardware object into a format readable by the system-level model.

33. The apparatus of claim 32 wherein (i) the system-level model comprises an API presenting an interface accurate with respect to boundaries of a system clock but having system-specific data and access requirements and (ii) the hardware object comprises an API that presents an interface accurate with respect to boundaries of a system clock but having object-specific data and access requirements, the mapping layer reconciling the requirements of the system-level API and each object-level API so as to facilitate data interchange therebetween while maintaining adherence to a system clock.

34. The apparatus of claim 33 wherein the mapping layer comprises an abstraction mapping module that itself comprises an abstract interface to the system-level model and a pin-level interface to a hardware object.

35. The apparatus of claim 34 wherein (i) the system-level model comprises an API presenting an interface accurate with respect to transactions and (ii) the hardware object comprises an API that presents an interface accurate with respect to the boundaries of a system clock, the mapping layer reconciling the transaction-based requirements of the system-level API and the clock-based requirements of each object-level API so as to facilitate data interchange therebetween while maintaining adherence to the system clock.

36. The apparatus of claim 35 further comprising a control object, the control object controlling advancement of time and execution of transactions to reconcile the transaction-accurate system-level API with the clock-based object-level APIs.

37. The apparatus of claim 24 wherein the mapping layer comprises a declaration module, an instantiation module, a sensitization module, an initialization module, an execution module, and an output scheduling module.

38. The apparatus of claim 37 wherein the declaration module is configured to define a template of the hardware object to facilitate interface with the system-level model.

39. The apparatus of claim 37 wherein the instantiation module is configured to create an instance of the hardware object, the instance comprising a data structure configured to receive data from the mapping layer.

40. The apparatus of claim 37 wherein the sensitization module comprises means enabling the mapping layer to detect a change to a pin of a pin-level interface of the hardware object, the change representing a signal which, if applied to a pin of a hardware element corresponding to the hardware object, would affect an output pin of the hardware element.

41. The apparatus of claim 40 wherein the change comprises assertion of at least one of (i) a clock signal, (ii) an asynchronous reset signal, and (iii) a signal affecting an output pin without requiring toggling of a system clock.

42. The apparatus of claim 37 wherein the hardware object comprises a data structure for receiving an initialization value from the initialization module.

43. The apparatus of claim 37 wherein the execution module is configured to (i) copy input data from the mapping layer to the hardware object, (ii) execute the hardware object in accordance with the input data, and (iii) copy output data from the hardware object to the mapping layer.

44. The apparatus of claim 37 wherein the output scheduling module is configured to determine when output data is copied from the mapping layer to the system-level model and to thereupon make the output data available to the system-level model.
